(19) United States
(12) Patent Application Publication
(10) Pub. No.: US 2006/0066443 A1
(43) Pub. Date: Mar. 30, 2006

(54) Self-adjusting RF assembly

(75) Inventor: David Malcolm Hall, Lockleys (AU)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Tagsys SA, La Penne-Sur Huveaune (FR)

(21) Appl. No.: 11/225,618

(22) Filed: Sep. 13, 2005

(30) Foreign Application Priority Data
Sep. 15, 2004 (AU) 2004905275

(51) Int. Cl. H04Q 5/22; H04B 17/00; G06F 17/00

(52) U.S. Cl. 340/10.5; 340/10.34; 235/375; 455/115.3

(57) ABSTRACT

A self adjusting RF assembly including an RF radiator is disclosed. The RF assembly includes at least one component that may be replaced by a user of the RF assembly. The RF assembly includes an identification element associated with the at least one component for representing at least one characteristic of the component. The RF assembly includes a monitoring element for monitoring the identification element at least during power up of the RF assembly. The RF assembly also includes an adjusting element for adjusting radiation from the RF radiator wherein the adjusting element is operably associated with the monitoring element to maintain radiation from the RF radiator below a preset limit. The preset limit is typically determined by local electromagnetic compatibility (EMC) regulations. A method for maintaining radiation from an RF assembly below a preset limit is also disclosed.

### FIELD OF THE INVENTION

The present invention relates to a self-adjusting radio frequency (RF) assembly that includes an RF radiator. In particular the present invention relates to a system for facilitating compliance with local electromagnetic compatibility (EMC) regulations at least when the RF assembly is reconfigured. The present invention has particular application in the field of radio frequency identification (RFID) tags that may be attached to objects which are to be used to identify, sort, control and/or audit the objects.

### BACKGROUND OF THE INVENTION

The RFID tags may be part of an object management system and may include information passing between an interrogator which creates an electromagnetic interrogation field and the RFID tags, which may respond by issuing a reply signal that is detected by the interrogator, decoded and consequently supplied to other apparatus in the sorting, controlling or auditing process. The objects to which the tags are attached may be animate or inanimate. In some variants of the system the frequency of the interrogation field may range from LF to UHF or microwave.

Under normal operation the tags may be passive, i.e. they may have no internal energy source and may obtain energy for their reply from the interrogation field, or they may be active and may contain an internal energy source, for example a battery. Such tags may respond only when they are within or have recently passed through the interrogation field. The interrogation field may include functions such as signaling to an active tag when to commence a reply or series of replies or in the case of passive tags may provide energy for passive tag operations along with any signaling.

In order to optimise an RF assembly such as a tag reading system it is sometimes necessary to change the antenna, or illumination device, connected to the interrogator. This may lead to increased electromagnetic radiation in one or more directions that may possibly exceed the local EMC regulations. A common step towards some end-user flexibility in the choice of a system's components is to offer a range of antennae, each best suited for a particular application or requirement. Examples of requirements may include, but are not limited to, long range, wide capture angle, circular vs linear polarisation, and communication link bandwidth. Although an end-user may reconfigure a tag reading system with various options offered by a manufacturer of the tag reading system, the system should be certified to comply with local EMC regulations with all available options. This typically results in the output power of the system being set to comply with EMC regulations the antenna with the highest peak or realised (or effective) gain. The necessity for such a conservative approach degrades the range of a tag reading system since it is often configured with antennae having gains less than the maximum offered by the manufacturer of the tag reading system.

Moreover under current EMC regulation regimes, certifying a system with the highest gain antenna does not prevent an end-user from being irresponsible, but merely serves to protect the manufacturer against usage of their product outside of its intended parameters. The present invention may provide an alternative scheme for changing antennae and/or associated components to obtain an optimum range for an RF assembly whilst maintaining compliance with local EMC regulations.

### SUMMARY OF THE INVENTION

According to one aspect of the present invention there is provided a self adjusting RF assembly including an RF radiator, said assembly including:
at least one component that may be replaced by a user of said RF assembly;
an identification element associated with said at least one component for representing at least one characteristic of said component;
a monitoring element for monitoring said identification element at least during power up of said RF assembly; and
an adjusting element for adjusting radiation from said RF radiator wherein said adjusting element is operably associated with said monitoring element to maintain radiation from said RF radiator below a preset limit.

According to a further aspect of the present invention there is provided a method for maintaining radiation from an RF assembly including an RF radiator below a preset limit, said method including:
associating an identification element with a component of said assembly that may be replaced by a user, said identification element being adapted to represent at least one characteristic of said component;
monitoring said identification element at least during power up of said RF assembly; and
adjusting said radiation in response to said monitoring such that radiation from said RF radiator is below said preset limit.

According to a still further aspect of the present invention there is provided an identification system for a component in an RF assembly including an RF radiator, said identification system including:
an identification element adapted to be associated with said component for representing at least one characteristic of said component; and
a monitoring element for monitoring said identification element at least during power up of said RF assembly, wherein said monitoring element is adapted to provide said at least one characteristic to an adjusting element in said RF assembly to maintain radiation from said RF radiator below a preset limit.

According to a still further aspect of the present invention there is provided a method for identifying a component in an RF assembly including an RF radiator, said method including:
associating an identification element with said component for representing at least one characteristic of said component; and
monitoring said identification element at least during power up of said RF assembly to provide said at least one characteristic to an adjusting element in said RF assembly adapted to maintain radiation from said RF radiator below a preset limit.

The present invention proposes a self adjusting RF assembly including an RF radiator. The RF assembly includes one or more components that may be replaced by a user. The components may include antennae, external antenna multiplexers, manufacturer supplied cable assemblies, and/or associated system and sub-system components. In the case of multiple antenna channels, an identification element may be applied to each antenna that is to be attached to the RF assembly. The identification element may allow the monitoring element to identify the antenna or associated component or components by a unique serial number or by a model number or by peak realised gain or the like. Upon identification of the antenna or component, the adjusting element may adjust output power of the RF assembly to a level consistent with local EMC regulations within which the assembly should be operated. In the event that the end-user connects an unidentified or unknown antenna or component to the assembly, ie. an antenna or component other than those specified by the manufacturer, the assembly may be placed into an inoperative state, such that presence of the unidentified or unknown antenna or component may not cause the assembly to exceed the local EMC regulations. This feature may include non-operation of the assembly without an antenna to protect the assembly from reflective overload. New antenna models or components may be included by updated reader firmware or certified and stored in memory by connecting to a database, with the update containing the model and/or serial numbers of permitted components.

A further embodiment of the assembly may include a geographic or jurisdictional feature to enable a correct local EMC regulation to be automatically selected by the assembly. The geographic or jurisdictional feature may include information relating to the geographic locality by means of a factory preset default, information relating to a telephone network, information relating to mains voltage, frequency and/or utility communication, global positioning system (gps) data, an internet based domain name service, and/or other suitable means.

Identification of an antenna or other replaceable component, may be implemented in any suitable manner and by any suitable means. In one form the identification may be implemented by means of an impedance attached to or otherwise associated with the replaceable component. The value of the impedance may be adapted to represent an allowable category or component. The category may be defined by a model number or by a number representing a peak realised gain including lossy items or items with numeric gains less than unity. The attached or associated impedance, which may or may not include a reactive component, may be “interrogated” by means of a primary rf cable connected to the antenna or other component as the case may be, or by means of a secondary cable, interface, or medium. For example, using a dc method, a resistor of one hundred ohms may represent a −10 dB gain (ie. 10 dB loss) while a resistor of one megohm may represent a 10 dB gain. A resistor below a value of say, ten ohms or above say, one megohm may represent a problem such as an unidentified antenna or component or no antenna or component respectively.

The dc resistance of a pathway to a remote antenna mounted resistor for a typical coaxial cable is less than 60 ohms/km. With runs rarely exceeding 10 m (100 m) the cable may add around 1 ohm (10 ohms) of resistance, making 100 ohms resolution for a numbering scheme feasible. An upper limit of 1 megohm may be chosen for induced noise considerations. If decibel increments were chosen to indicate antenna power gain, a suitable range of −20 dB to +15 dB would need 36 increments. It appears unlikely that antenna model numbers would require more than 36 levels.

Ignoring loss in the transmission line, and assuming that the antenna used in testing has a power gain of +2.15 dB, if a local regulation allows +36 dBm of output power (calculated from a field measurement at a predefined distance) then the applied power to the antenna may be (36-2.15) or +33.85 dBm. If an antenna of 6 dB gain was added, then the applied power would have to be reduced to +30 dBm. If a wide-band or wide-beam antenna was desired it might have 0 dB gain so that the applied power would have to be increased to +36 dBm. In each case the RFID tag activation distance would be equivalent.

In another form identification of a replaceable component may be implemented by means of an identification circuit such as an RFID tag. The RFID tag may be used to self-inventory components of the RF assembly, such as an antenna radiator, an antenna multiplexer, a cable assembly and a subsystem assembly.

### DESCRIPTION OF PREFERRED EMBODIMENTS

Preferred embodiments of the present invention will now be described with reference to the accompanying drawings wherein:

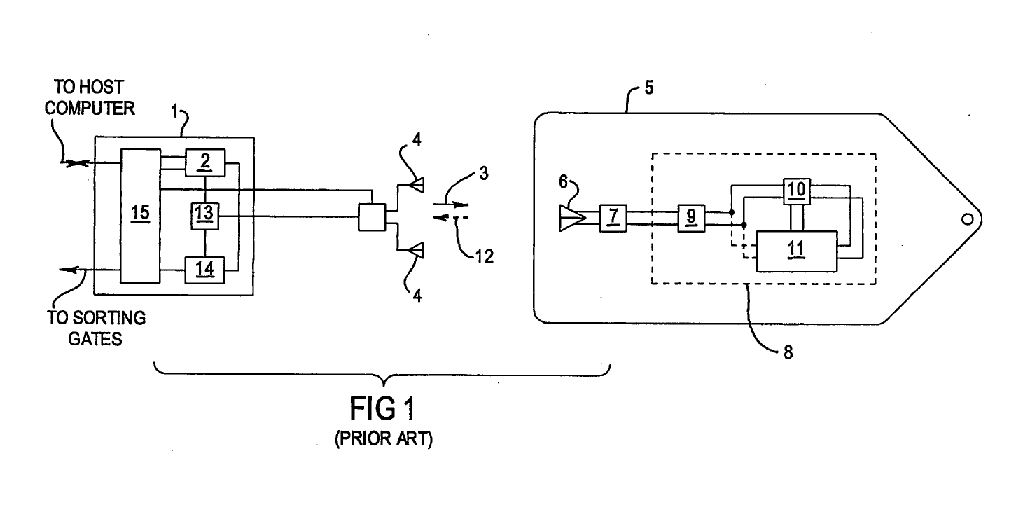

FIG. 1 shows major elements of a prior art object management system;

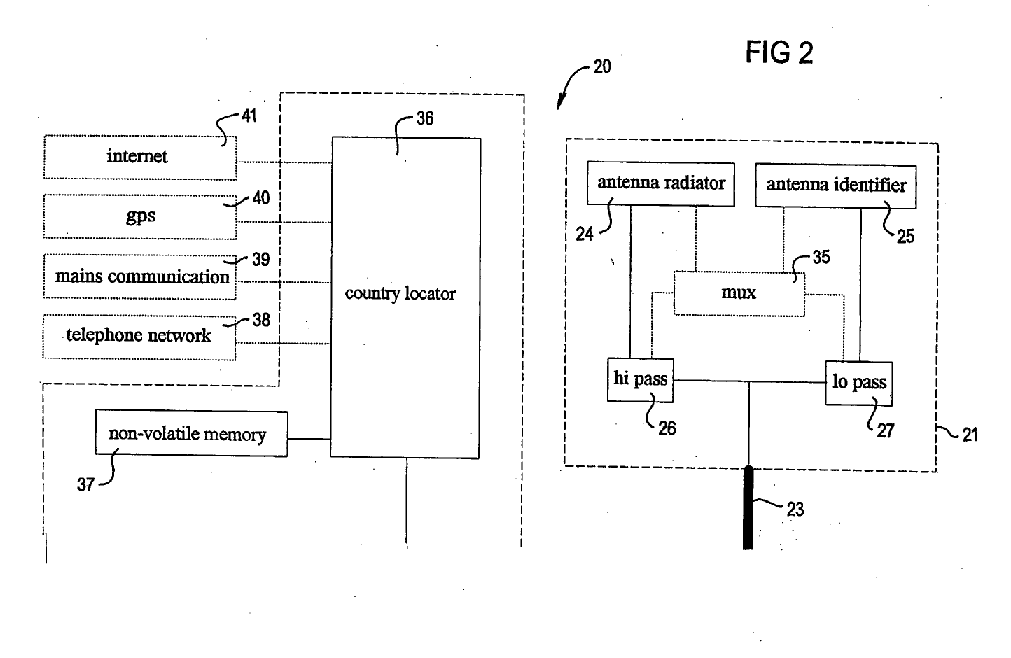

FIG. 2 shows one embodiment of an interrogator incorporating a self adjusting component identification system according to the present invention;

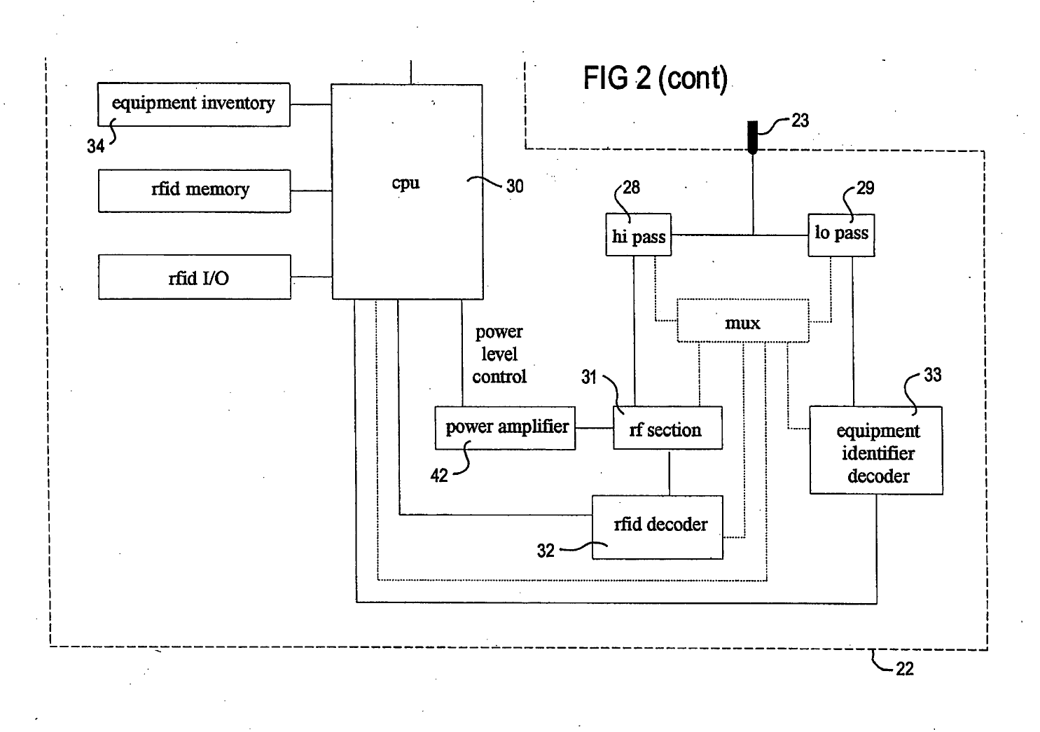

FIG. 3 shows an analog circuit for measuring a resistance associated with an antenna radiator;

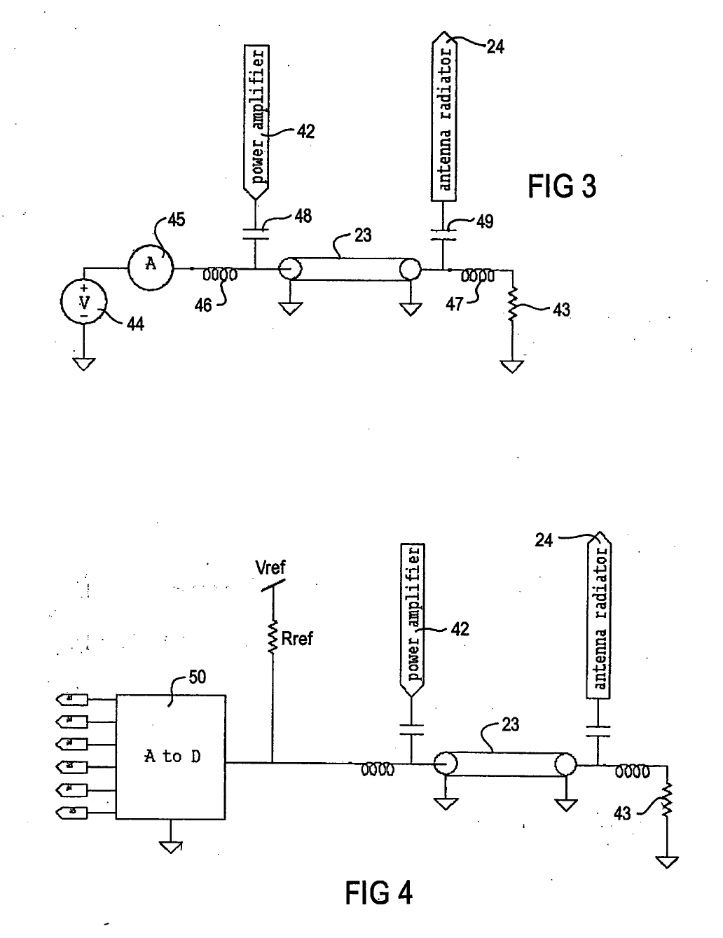

FIG. 4 shows a digital circuit for measuring a resistance associated with an antenna radiator;

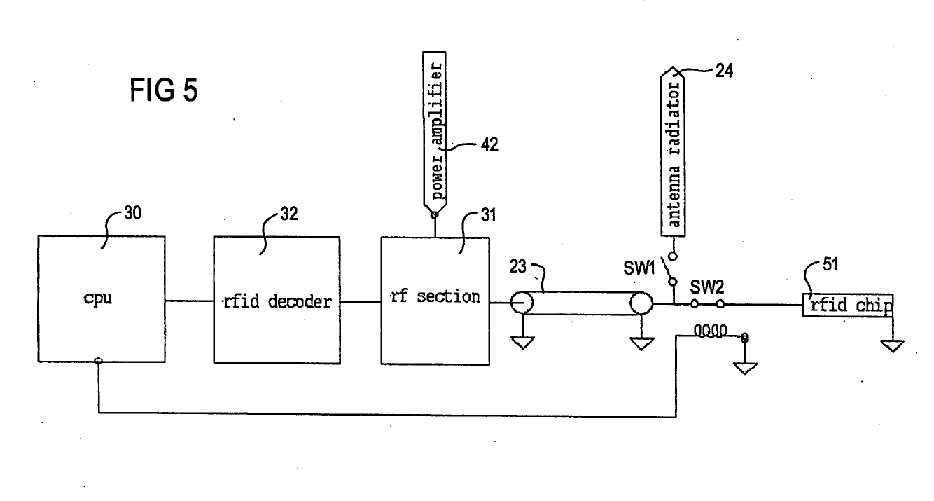

FIGS. 5 shows a circuit for reading an RFID chip associated with an antenna radiator;

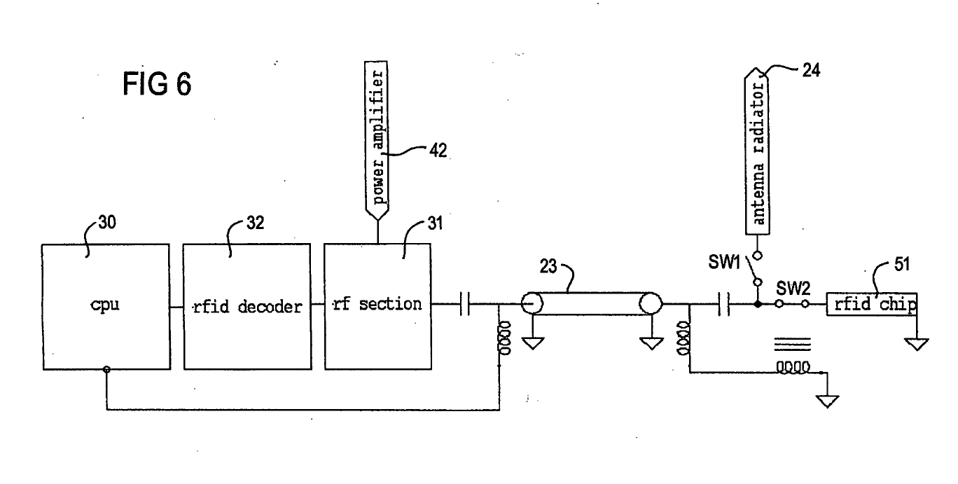

FIG. 6 shows another circuit for reading an RFID chip associated with an antenna radiator; and

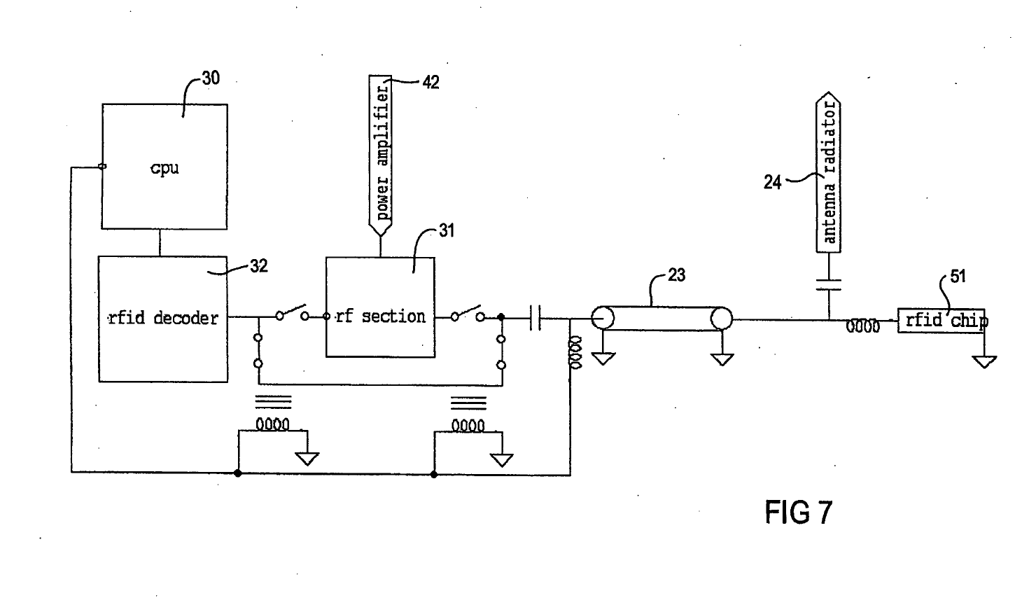

FIG. 7 shows a further circuit for reading an RFID chip associated with an antenna radiator.

FIG. 1 shows a typical arrangement of an interrogator system in which an interrogator 1 containing a transmitter 2 generates an electromagnetic signal 3 which is transmitted via interrogator antennae 4 to an electronic label 5 containing a label antenna 6. The label antenna 6 is connected via a matching element 7 to an integrated microcircuit 8 via a pair of terminals. Within integrated microcircuit 8 is an integrated matching element 9, preferably a capacitor, connected in parallel with the antenna 6 and matching element 7. The system of antenna 6, matching element 7 and integrated matching element 9 form a resonant circuit at the interrogation frequency so that coupling between the interrogator 1 and the label 5 is enhanced. The label antenna 6 receives a proportion of the transmitted energy and through operation of a rectifier 10 generates a dc power supply for operation of a reply generation circuit 11 connected to the label antenna 6 with the result that the an information bearing electromagnetic reply signal 12 is radiated by the label 5.

As a result of electromagnetic coupling between the label 5 and interrogator antennae 4, a portion of a time varying radio frequency signal transmitted by the label antenna 6 may enter the interrogator antennae 4 and in a signal separator 13 located within the interrogator 1 be separated from the signal transmitted by the interrogator 1 and passed to a receiver 14 wherein it is amplified, decoded and presented via a microcontroller 15 in digital or analog form to other systems such as a host computer or a system of sorting gates or the like which may make use of the information provided by the interrogator.

Referring to FIG. 2, the interrogator shown generally at 20 includes an antenna assembly 21 connected to an interrogator assembly 22 via transmission line 23. The antenna assembly 21 includes antenna radiator 24 and antenna identifier 25. Signals to/from antenna radiator 24 are sent from/to interrogator assembly 22 via high pass module 26. Signals to/from antenna identifier 25 are sent from/to interrogator assembly 22 via low pass module 27.

Interrogator assembly 22 includes a high pass section for normal RFID operation and a low pass section for component identification operation. Data from antenna assembly 21 is received in both high pass and low pass modules 28 and 29. Data from normal RFID operation of interrogator assembly 22 is extracted in high pass module 28 and is sent to central processing unit (cpu) 30 via RF section 31 and RFID decoder 32. Component identification data is extracted in low pass module 29 and is sent to central processing unit 30 via equipment identifier decoder 33.

Whilst it may only be necessary to identify equipment on power up and before normal RFID operations are performed, continuous monitoring of antenna assembly 21 is desirable to detect occurrence of a fault such as disconnection of an antenna to prevent damage to interrogator assembly 22.

For continuous monitoring, one form of antenna identifier 25 may be a resistor. The value of the identifier resistor may indicate an antenna gain or an antenna model number that may be compared with a table of look up values stored in equipment inventory 34 associated with interrogator assembly 22. As new antennae are released for general use, equipment inventory 34 may be updated with software to allow “old” interrogators to identify and operate with new antennae.

The value of the identifier resistor may be measured at low frequency with direct current. The value of the identifier resistor may be measured at least at power up or it may be measured at regular intervals to provide continuous monitoring of antenna assembly 21.

Alternatively, antenna identifier 25 may be provided by means of an electronically coded integrated circuit (IC) or identifier chip similar to that used in an RFID tag. The identifier chip through its data content, and/or any other parameter such as response frequency, may indicate the model or peak realised gain number, and/or further uniquely identify the antenna. The chip may be read by rf, dc (baseband), or other means. The identifier chip may be interrogated or read by interrogator assembly 22 in which case a multiplexer (mux) 35 or switch (refer FIG. 5) may be used to switch between a normal interrogation mode and an identification interrogation mode.

Mux 35 may be controlled by a dc signal passed down a conductor along transmission line 23. It may be controlled more elaborately by another RF signal including a modulated signal. The latter may constitute a miniature communication system in its own right.

Reading of the RFID tag acting as antenna identifier 25 may be performed via RF section 31 in the case where mux 35 simply selects between radiator 24 and identifier 25, or the tag might be activated directly at dc and a mux within the reader may port the signal directly to decoder 32 during antenna identification. A dedicated extra identifier decoder may be implemented by momentarily reconfiguring existing hardware for the identification process.

For a dedicated identity decoder a bypass network or a mux may be used to either isolate or switch the functions for use on a common transmission line. The decoder may be realised by a reconfiguration of existing hardware e.g. filter bandwidths, amplifier gains, programmable-logic-arrays, or some re-use of existing hardware. As a minimum a mux or a bypass network may be added to an otherwise standard RFID interrogator, with a control line to the mux or identity decoder from the cpu or micro-controller as well as additional software or firmware to add the identity feature.

Component identification may be performed periodically or during normal periods of non RFID communication, so that in the cases of an unidentified or a removed or damaged antenna, RF can be shut down (a short period of interrogator operation without an antenna would not be as detrimental to the hardware as extended periods of a shorted or opened cable) preventing hardware damage and/or violation of EMC regulations if the antenna was hot swapped for one not from an approved manufacturer.

Another form of antenna identifier 25 may include a simple oscillator (powered by RF directly or by loose coupling). The frequency of the oscillator may be identified and classified as belonging to an antenna having gain x or a certain model number. The oscillator in this case may be gated on and off by a control signal. The control or gate signal may be a DC signal.

The control or gate signal may be sent down the transmission line. The control signal may activate a switch, a PIN diode, a relay, a reversed biased diode, or a transistor which may allow RF to effectively travel through the chip or device to complete a measuring or detecting circuit.

Alternatively, a bypass network (low pass/high pass combination) may be used. The bypass network may use a frequency that is either higher or lower than the normal RFID carrier frequency with dc being one solution to the lower case. Use of dc may allow a simple bypass network or a mux. Use of RF other than the carrier may be possible with a bypass network if there is sufficient carrier offset frequency, otherwise a mux may be used.

Different frequency operation may be expanded to include a different protocol at the same frequency, or a different technology e.g. tag-talks-first or reader-talks-first, or different media e.g. optical and electromagnetic. The antenna identifier 25 may be decoded by RFID decoder 32 present in interrogator assembly 22 with inputs to decoder 32 being from RF section 31 or from a separate or direct-to-base-band connection. Alternatively, equipment identifier decoder 33 may be used.

Each component in a tag reading system may contain an equipment identifier, with each component possibly containing a different type of identifier. For example the interrogator may include an identifier based on an RFID chip containing both model and serial numbers whereas the antenna may include an identifier resistor only which may convey a model number or antenna radiator gain.

Geographic locality may be determined by means of country locator module 36. Country locator module 36 may include a factory preset default in non-volatile memory 37, telephone network 38 (landline or mobile), communication on the mains 39 (eg. main voltage, frequency, including any sniffing of utility communication which may determine the country of operation), gps 40, or the internet 41. Determination of locality via the internet may include use of internal knowledge including use of an IP number if it contains a web server function (common for remote entry of operating parameters). Alternatively, the country locator module 36 may visit a web page owned by the manufacturer to determine the IP number. Once the IP number is known a “whois” lookup may be used on that number (or the manufacturer's web page may perform the whois) to return country data. The data returned by a whois function may be in a required format for a machine to be connected to the internet.

Interrogator assembly 22 may obtain an appropriate power limit from a look up table after identifying the country of operation from available methods, and may combine this with the gain of the antenna retrieved by decoding a representation of the gain or model number of the antenna from a data field or a look up table to set a power applied to antenna radiator 24 that should be no greater than an allowed limit. There may be cases when full power operation may not be desired. The present invention does not require that maximum power should be used, only that this may be done in an automatic fashion.

In one form power may be controlled by taking a digital word from cpu 30 and decoding it with a digital to analogue converter into a control voltage or current which may be used to control the output of power amplifier 42. Another way to control power may be to decode the digital word with a “1 of n” mux having 1 input and n outputs, with each output being linked to a bias resistor which may set power amplifier 42 to 1 of n predefined output power levels.

Interrogator assembly 22 may be tested for EMC compliance with proposed combinations of antennae (including those with wide bandwidth) and all proposed operating modes. The present invention is concerned with RF power radiated from antenna radiator 24 when “bandwidth” or emissions other than carrier requirements are simultaneously fulfilled.

Each protocol for reading RFID tags may have a defined bandwidth. Hence, bandwidth may be reduced in the same manner as carrier power. Some modes of operation may need to be excluded if these cause the interrogator to fail when elevated power is used in a low gain antenna, or the amount of elevation may be reduced from optimum. However a customer may not place any antenna on the interrogator, only a certified antenna, and if the reader needs to exclude some operating mode at a certain power level it should preferably be in the interrogator. Poorly designed systems may need a model number for the antenna rather than just a simple gain figure because the firmware may need to be aware of restrictions on power or operating mode for that model of antenna. Two antennas with the same power gain may have different emissions other than the carrier.

FIG. 3 shows a circuit for measuring an antenna identifier comprising a resistor 43 which represents the gain of antenna radiator 24 using simple direct current to measure the value of resistor 43. The resistance measuring circuit includes voltage generator 44 and ammeter 45. The resistance measuring circuit is connected to resistor 43 via inductors 46, 47 and transmission line 23. Inductors 46, 47 are adapted to prevent RF carrier produced by power amplifier 42 from entering the resistance measuring circuit and resistor 43. The circuit includes capacitors 48, 49 to provide an RF connection between power amplifier 42 and antenna radiator 24 while preventing direct current interfering with the RF carrier.

FIG. 4 show a circuit similar to that shown in FIG. 3. However, the resistance measuring circuit is modified by replacing voltage generator 44 and ammeter 45 with a reference supply Vref, a reference resistor Rref and an analog to digital (A to D) converter 50. The value of resistor 43 is obtained by measuring the voltage at the (effective) junction of resistors Rref and 43 which form a classical voltage divider. A to D converter 50 converts the voltage at the junction to a digital word (eg. 6 bits for 64 levels) which is looked up in a table to determine the gain of antenna radiator 24 represented by resistor 43.

Although measurement of the value of resistor 43 may be easily implemented it may also be easily counterfeited. To address this, resistor 43 may be replaced with a network of components to provide a complex impedance having real and imaginary parts. Alternatively, a voltage dependent resistor may be used such that a non-trivial measurement of resistance will be required. In a further embodiment first and second resistors may be used together with a multiplexer so that the first resistor is used to calibrate the measuring system prior to measuring the second resistor that represents the gain or model number of the antenna radiator.

FIG. 5 shows a circuit for reading an antenna identifier comprising an RFID chip 51. RFID chip 51 is read via RF by interrogator assembly 22 during an interrogation mode in which switch contacts SW1 are open and switch contacts SW2 are closed. Switch contacts SW1 and SW2 are activated via a control signal sent down transmission line 23. Interrogator assembly 22 is returned to its normal interrogation mode by closing switch contacts SW1 and opening switch contacts SW2.

FIG. 6 shows a modification of the circuit of FIG. 5. FIG. 7 show a further modification of the circuit of FIG. 5 in which RFID chip 51 is activated at dc and is read at baseband by direct connection to RFID decoder 32.

Where the antenna identifier is provided by means of an electronically coded chip or tag, the tag may be read in such a manner as to be hidden from the end-user to protect against antenna counterfeiting. An identification tag may also be placed on or into other ancillary components. A further embodiment of the invention may include encryption in the antenna's tag so that a secure transaction between the reader and antenna may take place.

Finally, it is to be understood that various alterations, modifications and/or additions may be introduced into the constructions and arrangements of parts previously described without departing from the spirit or ambit of the invention.

1. A self adjusting RF assembly including an RF radiator, said assembly including:
at least one component that may be replaced by a user of said RF assembly;
an identification element associated with said at least one component for representing at least one characteristic of said component;
a monitoring element for monitoring said identification element at least during power up of said RF assembly; and
an adjusting element for adjusting radiation from said RF radiator wherein said adjusting element is operably associated with said monitoring element to maintain radiation from said RF radiator below a preset limit.

2. A self adjusting assembly according to claim 1 wherein said limit is determined by local electromagnetic compatibility regulations.

3. A self adjusting assembly according to claim 1 wherein said at least one characteristic includes one of a serial number, a model number, and a peak realized gain.

4. A self adjusting assembly according to claim 1 wherein said component includes at least one of an antenna radiator, an antenna multiplexer, a cable assembly and a sub-system assembly.

5. A self adjusting assembly according to claim 1 wherein said component comprises an antenna radiator and said at least one characteristic includes the gain of said antenna radiator.

6. A self adjusting assembly according to claim 1 wherein said identification element includes an impedance and wherein the value of said impedance provides a representation of said at least one characteristic.

7. A self adjusting assembly according to claim 1 wherein said identification element includes an integrated circuit having an embedded electronic code and wherein said code provides a representation of said at least one characteristic.

8. A self adjusting assembly according to claim 1 including a jurisdictional element for obtaining information relating to the geographic locality in which said RF assembly is installed.

9. A self adjusting assembly according to claim 8 wherein said information includes at least one of a factory preset default, information relating to a telephone network, information relating to mains voltage, frequency and/or utility communication, gps data and/or an internet connection.

10. A method for maintaining radiation from an RF assembly including an RF radiator below a preset limit, said method including:
associating an identification element with a component of said assembly that may be replaced by a user, said identification element being adapted to represent at least one characteristic of said component;
monitoring said identification element at least during power up of said RF assembly; and
adjusting said radiation in response to said monitoring such that radiation from said RF radiator is below said preset limit.

11. A method according to claim 10 wherein said limit is determined by local electromagnetic compatibility regulations.

12. A method according to claim 10 wherein said at least one characteristic includes one of a serial number, a model number, and a peak realized gain.

13. A method according to claim 10 wherein said component includes at least one of an antenna radiator, an antenna multiplexer, a cable assembly and a sub-system assembly.

14. A method according to claim 10 wherein said component comprises an antenna radiator and said at least one characteristic includes the gain of said antenna radiator.

15. A method according to claim 10 wherein said identification element includes an impedance and wherein the value of said impedance provides a representation of said at least one characteristic.

16. A method according to claim 10 wherein said identification element includes an integrated circuit having an embedded electronic code and wherein said code provides a representation of said at least one characteristic.

17. A method according to claim 10 including obtaining information relating to the geographic locality in which said RF assembly is installed.

18. A method according to claim 17 wherein said information includes at least one of a factory preset default, information relating to a telephone network, information relating to mains voltage, frequency and/or utility communication, gps data and/or an internet connection.

19. An identification system for a component in an RF assembly including an RF radiator, said identification system including:
an identification element adapted to be associated with said component for representing at least one characteristic of said component; and
a monitoring element for monitoring said identification element at least during power up of said RF assembly, wherein said monitoring element is adapted to provide said at least one characteristic to an adjusting element in said RF assembly to maintain radiation from said RF radiator below a preset limit.

20. A method for identifying a component in an RF assembly including an RF radiator, said method including:
associating an identification element with said component for representing at least one characteristic of said component; and
monitoring said identification element at least during power up of said RF assembly to provide said at least one characteristic to an adjusting element in said RF assembly adapted to maintain radiation from said RF radiator below a preset limit.
